(19) United States
(12) Patent Application Publication
(10) Pub. No.: US 2013/0048153 A1
(43) Pub. Date: Feb. 28, 2013

(54) High-Temperature Solder with Multi-Layer Structure and Manufacturing Method Thereof

(71) Applicants: Yee-Wen Yen, Taipei (TW); Pei-Sheng Shao, Taipei (TW)

(72) Inventors: Yee-Wen Yen, Taipei (TW); Pei-Sheng Shao, Taipei (TW)

(73) Assignee: National Taiwan University of Science and Technology, Taipei (TW)

(21) Appl. No.: 13/246,829

(22) Filed: Sep. 27, 2011

(30) Foreign Application Priority Data
Aug. 26, 2011 (TW) 100130757

(51) Int. Cl. C25D 5/50; C25D 5/34; B32B 15/01; C25D 7/00

(52) U.S. Cl. 148/518; 148/405

(57) ABSTRACT

A high-temperature solder with multi-layer structure and method for manufacturing the same are disclosed. The high-temperature solder with multi-layer structure comprises: at least one first substrate and a second substrate. Wherein a first metal layer is formed on one surface of the first substrate by way of electroplating, and a second metal layer and a third metal layer are sequentially formed on the two surfaces of the second substrate through the electroplating. The first substrate is stacked on the third metal layer of the second substrate by the surface thereof provided with the first metal layer, so that the third metal layer and the first metal layer may jointly form an intermetallic (IMC) layer by way of the solid-liquid interdiffusion joint, in which the IMC layer includes at least one intermetallic compound for making the melting point of the high-temperature solder with multi-layer structure higher than 300-deg Celsius.

### BACKGROUND OF THE INVENTION

1. Technical Field

The present invention relates to a solder structure, and more particularly, to a high-temperature solder with multi-layer structure suitable for replacing the traditional high-temperature solder containing lead.

2. Description of Related Art

Recently, with vigorous development of the semiconductor and ICs design industries, electronic packaging technologies are also developed rapidly. Electronic packaging technologies are used for connecting the ICs fabricated by semiconductor process with others relative electronic components.

For preventing from the influence caused by the next jointing process, for example, wave soldering or reflow, it may selectively used a material with the melting point thereof greater than 250° C. as the first stage jointing material (solder) when connecting the electronic components; Therefore, when executing the next jointing process, it is able to avoid from the failure of solder joints due to the operation temperature is higher than the melting point of the first stage jointing material. In industries, Sn—Pb alloy solder is commonly used because it performs high reliability, wettability, conductivity, toughness, strength, melting point, creep behavior resistance, and corrosion resistance; moreover, the price of the Sn—Pb alloy solder is relatively cheap. To the Sn—Pb alloy solder, for instance, the Sn-95Pb solder, including solidus temperature and liquidus temperature at 300° C. and 314° C., respectively. So that, the Sn-95Pb solder is used as a high-temperature solder since the operation temperature of the Sn-95Pb solder for high-temperature welding is ranged from 300° C. to 350° C.

However, Pb is a heavy metal, which not only causes serious pollution to the environment but also damages nervous system, kidney and liver of human body. For this reason, European Union has been legislated for formally issuing Waste Electrical and Electronic Equipment Regulations (WEEE) and Restriction of Hazardous Substances (RoHS), so as to limit and forbid the electrical products including the substances harmful to human. Accordingly, in order to comply with the relative laws and the environmental demands, the manufacturers of electronic packaging do the research and development incessantly, and then propose relevant lead-free solders.

So far, the developed lead-free solders includes Sn—Ag(—Cu), Sn—Cu(—Ni) and Sn—Bi—Cu alloy belonging to I group as well as Sn—Zn(—Bi) and Sn—In—Ag—Bi alloy belonging to II group, wherein the melting points of the I group alloys are determined and ranged from 210° C. to 230° C. and the melting points of the II group alloys are determined and ranged from 180° C. to 210° C. Therefore, through above descriptions, it can easily understand that the melting points of the I group alloys and the II group alloys are not adequate high for being used as the first stage jointing materials.

Accordingly, in view of that the traditional solders contains lead (Pb) and are harmful to environment and human body, and the melting points of the developed I group and II group alloys are not adequate high for being the first stage jointing materials applied to the high-temperature jointing process, the inventors of the present invention have made great efforts to make inventive research thereon and eventually provided a high-temperature solder with multi-layer structure and a manufacturing method thereof, the inventors expect that the high-temperature solder with multi-layer structure can be used for replacing the traditional high-temperature solder containing lead.

### BRIEF SUMMARY OF THE INVENTION

The primary objective of the present invention is to provide a high-temperature solder with multi-layer structure, in which, a multi-layer structure consisting of indium/nickel/copper/nickel/indium and a tin/copper structure are stacked and reflowed under 200° C., 240° C. and 300° C., respectively; therefore a multi-layer structure consisting of copper/intermetallic layer/nickel/copper/nickel/intermetallic layer/copper is formed and can be used for replacing the traditional high-temperature solder containing lead.

Accordingly, for achieving the primary objective of the present invention, the inventors of the present invention propose a high-temperature solder with multi-layer structure, comprising:

at least one first substrate, having a first metal layer formed on one surface thereof by way of electroplating; and

a second substrate, having a second metal layer and a third metal layer sequentially formed on two surfaces thereof, wherein the second metal layer is used for being a diffusion barrier layer;

wherein the at least one first substrate is stacked on the third metal layer of the second substrate by the surface thereof provided with the first metal layer, so that the third metal layer and the first metal layer may jointly form an intermetallic layer including at least one intermetallic compound by way of a solid-liquid interdiffusion joint.

The second objective of the present invention is to provide a method for manufacturing a high-temperature solder with multi-layer structure; therefore, through the method, a high-temperature solder with multi-layer structure can be fabricated by way of a set of complete manufacturing steps.

Thus, in order to achieve the second objective of the present invention, the inventors propose a method for manufacturing a high-temperature solder with multi-layer structure, comprising steps of:
(1) grinding the surfaces of at least one first substrate and a second substrate;
(2) polishing the surfaces of the at least one first substrate and the second substrate;
(3) putting the first substrate and the second substrate into an ultrasonic vibration device, and washing the first substrate and the second substrate with water;
(4) using an alkaline solution to remove the oil stains on the surfaces of the first substrate and the second substrate by way of caustic wash;
(5) using an acid solution to eliminate the metal impurities on the surfaces of the first substrate and the second substrate through acid wash;
(6) washing the first substrate and the second substrate with water for cleaning the remained alkaline solution and acid solution;
(7) disposing the at least one first substrate in a first metal electroplating solution, so as to form a first metal layer on one surface of the first substrate;
(8) disposing the second substrate in a second metal electroplating solution for forming a second metal layer on two surfaces of the second substrate;
(9) disposing the second substrate in a third metal electroplating solution for forming a third metal layer on the second metal layer;
(10) stacking the first substrate on the third metal layer of the second substrate by the surface of the first substrate formed with the first metal layer;
(11) facilitating the third metal layer and the first metal layer jointly form an intermetallic layer including at least one intermetallic compound by way of a solid-liquid interdiffusion joint; and
(12) performing an aging heat treatment to the first substrate and the second substrate.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1A and FIG. 1B are schematic structure views of a high-temperature solder with multi-layer structure according to the present invention;

FIG. 2 is a backscattered electron image of the high-temperature solder with multi-layer structure according to the present invention;

FIG. 3A and FIG. 3A are flow charts of a method for manufacturing the high-temperature solder with multi-layer structure according to the present invention;

FIG. 4 is a second backscattered electron image of the high-temperature solder with multi-layer structure according to the present invention; and

FIG. 5 is a third backscattered electron image of the high-temperature solder with multi-layer structure according to the present invention.

### DETAILED DESCRIPTION OF THE INVENTION

To more clearly describe a high-temperature solder with multi-layer structure and a manufacturing method thereof according to the present invention, embodiments of the present invention will be described in detail with reference to the attached drawings hereinafter.

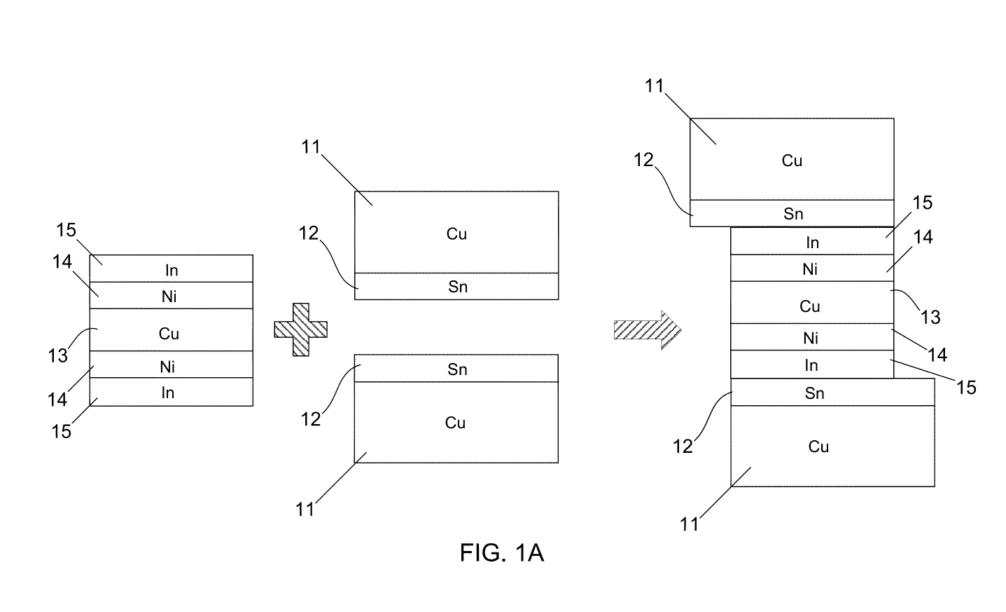

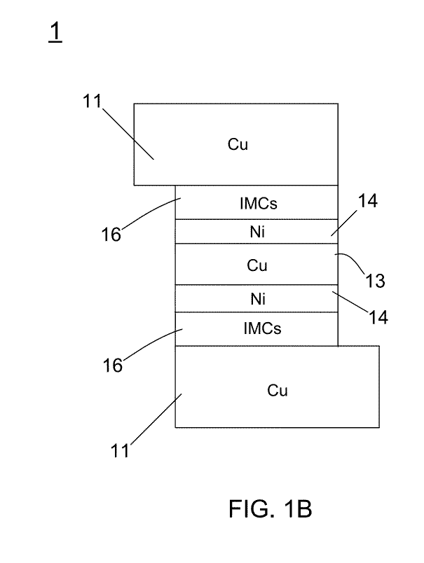

At first, a high-temperature solder with multi-layer structure of the present invention will be described. Please refer to FIG. 1A and FIG. 1B, there are shown schematic structure views of a high-temperature solder with multi-layer structure according to the present invention. The high-temperature solder 1 with multi-layer structure includes two first substrates 11 and a second substrate 13, wherein the first substrate 11 has a first metal layer 12 formed on one surface thereof by way of electroplating, and the second substrate 13 has a second metal layer 14 and a third metal layer 15 sequentially formed on the two surfaces thereof. In the present invention, the two first substrates 11 are respectively stacked on the two third metal layers 15 of the second substrate 13 by the surface thereof provided with the first metal layer 12; So that, as shown in FIG. 1B, the third metal layer 15 and the first metal layer 12 may jointly form an intermetallic layer 16 including multi intermetallic compounds (IMCs) by way of a solid-liquid interdiffusion joint.

In the structure of the high-temperature solder 1, the first substrate 11 is made of copper with 1 mm thickness and the second substrate 13 is made of copper with 50 μm thickness. Moreover, the first metal layer 12 is fabricated by forming tin (Sn) layer with 10 μm thickness on the first substrate 11. Herein, it must note that, for the high-temperature solder 1 with multi-layer structure of the present invention, the manufacturing material of the first metal layer 12 is not limited to tin but also can be silver (Ag) or Sn—Ag composite metal. The second metal layer 14 on the second substrate 13 is used as a diffusion barrier and the manufacturing material thereof can be nickel (Ni), wolfram (W), molybdenum (Mo), or palladium (Pd), and preferably, in the present invention, the second metal layer 14 is fabricated by forming Ni layer with 5 μm thickness on the second substrate 13. Furthermore, in the present invention, it eventually fabricates the third metal layer 15 by way of forming indium (In) layer with 10 μm thickness on the second metal layer 14, wherein the indium layer has low melting point property and is suitable for being the medium of the solid-liquid interdiffusion joint.

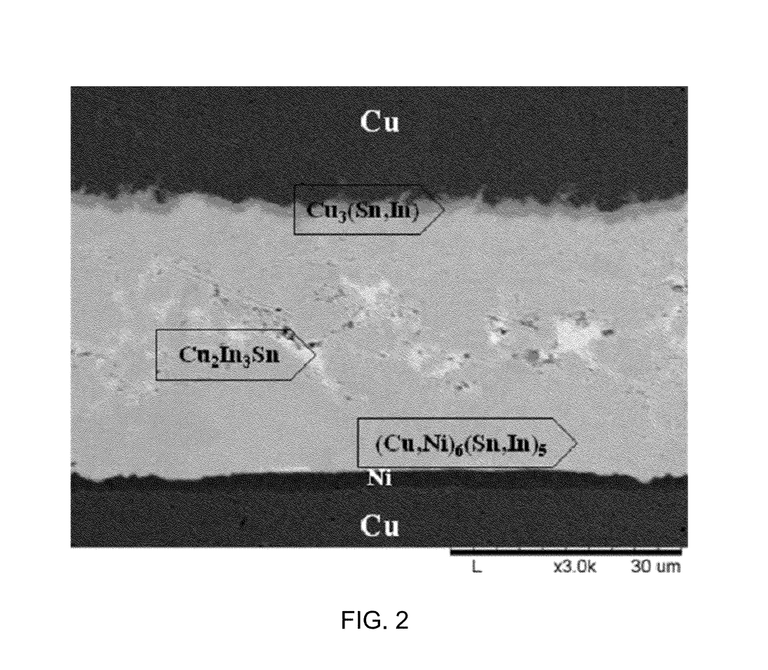

Referring to FIG. 1A and FIG. 1B again, and please simultaneously refer to FIG. 2, which illustrates a backscattered electron image of the high-temperature solder with multi-layer structure according to the present invention. When the solid-liquid interdiffusion joint of the third metal layer 15 and the first metal layer 12 are completed by using reflow process under 300° C., the intermetallic layer 16 is formed; In addition, as shown in FIG. 1B and FIG. 2, the intermetallic layer 16 includes three intermetallic compounds (IMCs) consisting of (Cu,Ni)₆(Sn,In)₅, Cu₂In₃Sn and Cu₃(Sn,In). Thus, through the formation of the intermetallic compounds, the melting point of the high-temperature solder 1 with multi-layer structure may higher than 300° C.; moreover, the melting point of the high-temperature solder 1 with multi-layer structure can also be controlled and ranged from 240° C. to 270° C. Wherein the control of the melting point of the high-temperature solder 1 is relative to the manufacturing method of the high-temperature solder 1, and the manufacturing method of the high-temperature solder 1 will be introduced in following descriptions; Furthermore, after the manufacturing method of the high-temperature solder 1 is introduced, the way to control the melting point of the high-temperature solder 1 will be continuously introduced though the auxiliary of experimental data.

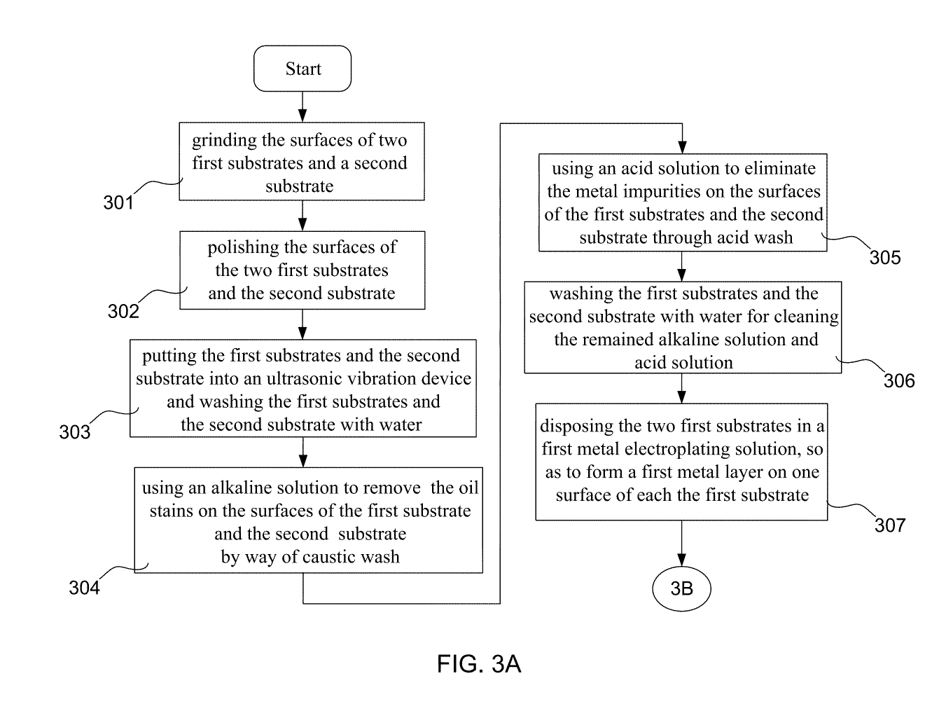

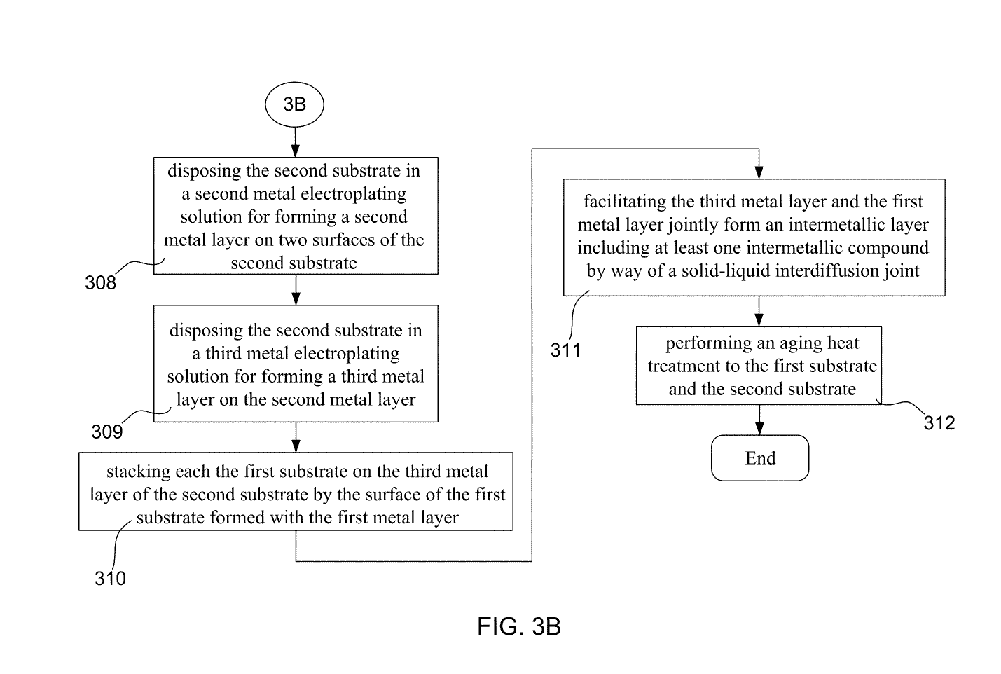

So that, the framework and structure of the high-temperature solder with multi-layer structure of the present invention have been clearly and completely introduced; Next, the method for manufacturing the high-temperature solder with multi-layer structure will be described. Please refer to FIG. 3A and FIG. 3B, there are shown the flow charts of the method for manufacturing the high-temperature solder with multi-layer structure according to the present invention. As shown in FIG. 3A and FIG. 3B, the method for manufacturing the high-temperature solder with multi-layer structure includes steps of: (Please refer the element numerics mentioned in following descriptions to the high-temperature solder with multi-layer structure illustrated in FIG. 1A and FIG. 1B.)

Firstly, the method flow is proceeded to step (301), grinding the surfaces of two first substrates 11 and a second substrate 13. In step (301), the first substrate 11 is a copper substrate with 1 mm thickness and the second substrate is a copper substrate with 50 μm, and the sandpapaers of number 800, number 1200, number 2400, and number 4000 are used sequentially for grinding the surfaces of the two first substrates 11 and the second substrate 12. Next, step (302) is executed after the step (301) is completed. In step (302), the surfaces of the two first substrates 11 and the second substrate 12 are polished by sequentially using aluminum powder with 1.0 μm grain size and aluminum powder with 0.3 μm grain size.

Continuously, the method flow is proceeded to step (303), putting the first substrates 11 and the second substrate 12 into an ultrasonic vibration device, and washing the first substrates 11 and the second substrate 12 with water, and then step (304) is executed. In step (304), it uses an alkaline solution to remove the oil stains on the surfaces of the first substrates 11 and the second substrate 12 by way of caustic wash. After completing the step (304), step (305) is sequentially executed in the method flow, in which, an acid solution is used to eliminate the metal impurities on the surfaces of the first substrates 11 and the second substrate 12 through acid wash. Next, the method flow is proceeded to step (306), that is, washing the first substrates 11 and the second substrate 12 with water for cleaning the remained alkaline solution and acid solution.

After cleaning the surfaces of the two first substrates 11 and the second substrate 12, the method flow is next proceeded to step (307), wherein each the first substrate 11 is disposed in a first metal electroplating solution for forming a first metal layer 12 on one surface thereof. In the step (307), because the first metal electroplating solution is the raw material for forming the first metal layer 12, the first metal electroplating solution may be tin (Sn) electroplating solution, silver (Ag) electroplating solution and tin-silver composite electroplating solution; and preferably, in the method for manufacturing the high-temperature solder with multi-layer structure of the present invention, it selectively used the tin electroplating solution as the first metal electroplating solution for forming first metal layer 12 on the surface of the first substrate 11.

Next, the method flow proceeded to step (308), disposing the second substrate 13 in a second metal electroplating solution for forming a second metal layer 14 on two surfaces of the second substrate 13. Since the second metal layer 14 is a diffusion barrier in the high-temperature solder 1 with multi-layer structure, the second metal electroplating solution can be nickel (Ni) electroplating solution, tungsten (W) electroplating solution, molybdenum (Mo) electroplating solution, and palladium (Pd) electroplating solution. Preferably, in the step (308) of the method for manufacturing the high-temperature solder 1 with multi-layer structure, the nickel electroplating solution is selectively used as the second metal electroplating solution. Sequentially, step (309) is executed. In the step (309), the second substrate 13 is disposed in a third metal electroplating solution for forming a third metal layer 15 on the second metal layer 14, wherein indium (In) electroplating solution is used for being the third metal electroplating solution because third metal layer 15 must be a specific metal layer with low melting point property. So that, by using the indium electroplating solution as the third metal electroplating solution, the indium layer is formed on the second metal layer 14 formed on the surface of the first substrate 11.

After finishing the electroplating of the metal layers on the first substrates 11 and the second substrate 13, the method flow is next proceeded to step (310), respectively stacking the two first substrates 11 on the two third metal layers 15 of the second substrate 13 by the surface of the first substrate 11 formed with the first metal layer 12, and then step (311) is executed. In the step (311), the third metal layers 15 and the first metal layers 12 jointly form an intermetallic layer 16 including at least one intermetallic compound by way of a solid-liquid interdiffusion joint. Moreover, it must note that, in the step (311), the solid-liquid interdiffusion joint is completed through a reflow soldering process. Finally, the method flow is proceeded to step (312), performing an aging heat treatment to the first substrates 11 and the second substrate 13, and the aging heat treatment is completed by disposing the first substrates 11 and the second substrate 13 in an environment with a specific temperature for 50, 100, 200, 400, 800, 1000, and 1500 hours, respectively.

Thus, through above descriptions, the method for manufacturing the high-temperature solder with multi-layer structure has been clearly introduced. For proving the characteristics and the performance of the high-temperature solder with multi-layer structure fabricated by using aforesaid method, in following, experimental data will be provided and shown.

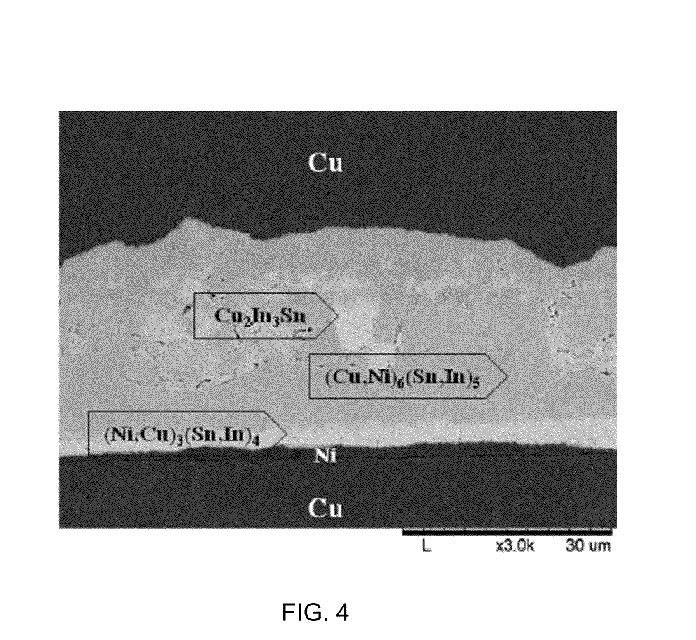

Referring to FIG. 1A and FIG. 1B again, and please simultaneously refer to FIG. 4, which illustrates a second backscattered electron image of the high-temperature solder with multi-layer structure according to the present invention. As shown in FIG. 1A, FIG. 1B and FIG. 4, the high-temperature solder 1 with multi-layer structure is made through the solid-liquid interdiffusion joint of the third metal layers 15 and the first metal layers 12 under the reflow soldering process with 200° C. operation temperature, and the intermetallic layer 16 formed by the third metal layer 15 and the first metal layer 12 includes three intermetallic compounds (IMCs) consisting of (Cu,Ni)₆(Sn,In)₅, Cu₂In₃Sn and (Ni,Cu)₃(Sn,In)₄. In addition, after executing the aging heat treatment by disposing the high-temperature solder 1 in an 100° C. environment for 50, 100, 200, 400, 800, 1000, and 1500 hours, respectively, the area ratio of the (Cu,Ni)₆(Sn,In)₅ and the Cu₂In₃Sn in the intermetallic layer 16 decreases from 6:1 to 1.5:1.

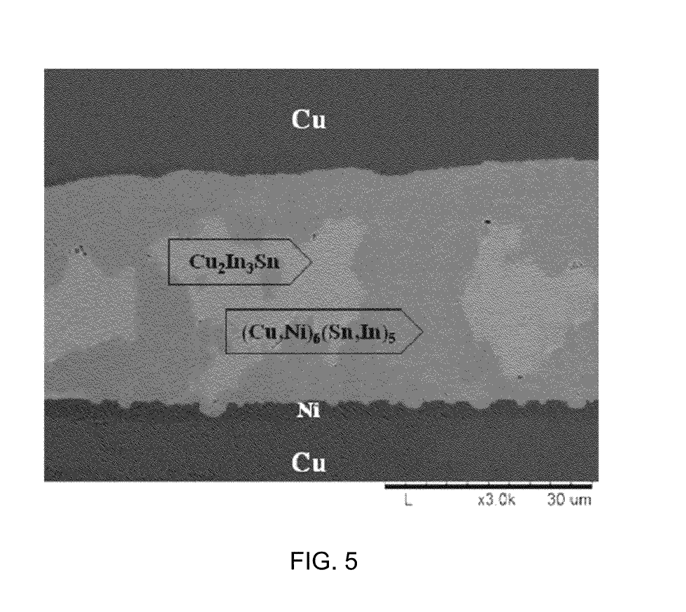

Please refer to FIG. 5, there is shown a third backscattered electron image of the high-temperature solder with multi-layer structure according to the present invention. As shown in FIG. 5, the high-temperature solder 1 with multi-layer structure is made through the solid-liquid interdiffusion joint of the third metal layers 15 and the first metal layers 12 under the reflow soldering process with 240° C. operation temperature, and the intermetallic layer 16 formed by the third metal layer 15 and the first metal layer 12 includes merely two intermetallic compounds (IMCs) consisting of (Cu,Ni)₆(Sn,In)₅ and Cu₂In₃Sn. Besides, after executing the aging heat treatment by disposing the high-temperature solder 1 in an 100° C. environment for 50, 100, 200, 400, 800, 1000, and 1500 hours, respectively, similarly, the area of Cu₂In₃Sn gradually expands in the intermetallic layer 16, such that the area ratio of the (Cu,Ni)₆(Sn,In)₅ and the Cu₂In₃Sn decreases from 2.2:1 to 1:1.

Eventually, please refer to FIG. 2 again. as shown in FIG. 2, the high-temperature solder 1 with multi-layer structure is made through the solid-liquid interdiffusion joint of the third metal layers 15 and the first metal layers 12 under the reflow soldering process with 300° C. operation temperature, and the intermetallic layer 16 formed by the third metal layer 15 and the first metal layer 12 includes three intermetallic compounds (IMCs) consisting of (Cu,Ni)₆(Sn,In)₅, Cu₂In₃Sn and Cu₃(Sn,In). In addition, after executing the aging heat treatment by disposing the high-temperature solder 1 in an 100° C. environment for 50, 100, 200, 400, 800, 1000, and 1500 hours, respectively, differently, the area ratio of the (Cu,Ni)₆(Sn,In)₅ and the Cu₂In₃Sn in the intermetallic layer 16 has no obvious change with the executing time of the aging heat treatment going.

Therefore, by above the experimental data, it can know that the high-temperature solder 1 with multi-layer structure made by the reflow soldering process with 300° C. operation temperature has more IMCs of (Cu,Ni)₆(Sn,In)₅ and Cu₃(Sn,In) in the intermetallic layer 16 thereof, and the IMCs of (Cu,Ni)₆(Sn,In)₅ and Cu₃(Sn,In) make the melting point of the high-temperature solder 1 higher than 300° C.; So that, the high-temperature solder 1 with multi-layer structure made by the reflow soldering process with 300° C. operation temperature is suitable for being used to replace the traditional high-temperature solder containing lead (Pb). Besides, the high-temperature solder 1 with multi-layer structure made by the reflow soldering process with 200° C. or 240° C. operation temperature can also be used for replacing the traditional low-temperature solder containing lead.

Thus, through above descriptions, the high-temperature solder with multi-layer structure and the manufacturing method thereof of the present invention have been clearly disclosed and introduced; In summary, the present invention has the following advantages:
1. In the present invention, a multi-layer structure consisting of indium/nickel/copper/nickel/indium and a tin/copper structure are stacked and reflowed under 300° C. operation temperature, therefore a multi-layer structure consisting of copper/intermetallic layer/nickel/copper/nickel/intermetallic layer/copper is formed, in which the intermetallic layer includes the intermetallic compounds (IMCs) consisting of (Cu,Ni)₆(Sn,In)₅ and Cu₂In₃Sn, and the IMCs of the (Cu,Ni)₆(Sn,In)₅ and the Cu₂In₃Sn makes the melting point of the high-temperature solder 1 higher than 300° C., and suitable for being used to replace the traditional high-temperature solder containing lead.
2. In the present invention, a multi-layer structure consisting of indium/nickel/copper/nickel/indium and a tin/copper structure can also be are stacked and reflowed under 200° C. or 240° C. operation temperature, therefore a multi-layer structure consisting of copper/intermetallic layer/nickel/copper/nickel/intermetallic layer/copper is formed, moreover, by the different composition of the intermetallic compounds (IMCs) in the intermetallic layer, the melting point of the high-temperature solder 1 may be changed, such that the high-temperature solder 1 can be used for replacing the traditional low-temperature solder containing lead.

The above description is made on embodiments of the present invention. However, the embodiments are not intended to limit scope of the present invention, and all equivalent implementations or alterations within the spirit of the present invention still fall within the scope of the present invention.

We claim:

1. A high-temperature solder with multi-layer structure, comprising:
at least one first substrate, having a first metal layer formed on one surface thereof by way of electroplating; and
a second substrate, having a second metal layer and a third metal layer sequentially formed on two surfaces thereof, wherein the second metal layer is used for being a diffusion barrier layer;
wherein the at least one first substrate is stacked on the third metal layer of the second substrate by the surface thereof provided with the first metal layer, so that the third metal layer and the first metal layer may jointly form an intermetallic layer including at least one intermetallic compound by way of a solid-liquid interdiffusion joint.

2. The high-temperature solder with multi-layer structure of claim 1, wherein the manufacturing materials of the first substrate and the second substrate are copper.

3. The high-temperature solder with multi-layer structure of claim 1, wherein the manufacturing material of the first metal layer is selected from the group consisting of: tin, silver and tin-silver composite metal.

4. The high-temperature solder with multi-layer structure of claim 1, wherein the manufacturing material of the second metal layer is selected from the group consisting of: nickel, tungsten, molybdenum, and palladium.

5. The high-temperature solder with multi-layer structure of claim 1, wherein the manufacturing material of the third metal layer is indium with low melting point property.

6. The high-temperature solder with multi-layer structure of claim 1, wherein the aforesaid solid-liquid interdiffusion joint is completed through a reflow soldering process.

7. The high-temperature solder with multi-layer structure of claim 1 having the melting point greater than 400° C.

8. The high-temperature solder with multi-layer structure of claim 1 having the melting point ranging from 240° C. to 270° C.

9. A method for manufacturing a high-temperature solder with multi-layer structure, comprising steps of:
(1) grinding the surfaces of at least one first substrate and a second substrate;
(2) polishing the surfaces of the at least one first substrate and the second substrate;
(3) putting the first substrate and the second substrate into an ultrasonic vibration device, and washing the first substrate and the second substrate with water;
(4) using an alkaline solution to remove the oil stains on the surfaces of the first substrate and the second substrate by way of caustic wash;
(5) using an acid solution to eliminate the metal impurities on the surfaces of the first substrate and the second substrate through acid wash;
(6) washing the first substrate and the second substrate with water for cleaning the remained alkaline solution and acid solution;
(7) disposing the at least one first substrate in a first metal electroplating solution, so as to form a first metal layer on one surface of the first substrate;
(8) disposing the second substrate in a second metal electroplating solution for forming a second metal layer on two surfaces of the second substrate;
(9) disposing the second substrate in a third metal electroplating solution for forming a third metal layer on the second metal layer;
(10) stacking the first substrate on the third metal layer of the second substrate by the surface of the first substrate formed with the first metal layer;
(11) facilitating the third metal layer and the first metal layer jointly form an intermetallic layer including at least one intermetallic compound by way of a solid-liquid interdiffusion joint; and
(12) performing an aging heat treatment to the first substrate and the second substrate.

10. The method for manufacturing the high-temperature solder with multi-layer structure of claim 9, wherein the step (1) further comprises detailed steps of:
(11) grinding the surfaces of the at least one first substrate and the second substrate by using a sandpapaer of number 800;
(12) grinding the surfaces of the at least one first substrate and the second substrate by using a sandpapaer of number 1200;
(13) grinding the surfaces of the at least one first substrate and the second substrate by using a sandpapaer of number 2400; and
(14) grinding the surfaces of the at least one first substrate and the second substrate by using a sandpapaer of number 4000.

11. The method for manufacturing the high-temperature solder with multi-layer structure of claim 9, wherein the step (2) further comprises detailed steps of:
(21) polishing the surfaces of the at least one first substrate and the second substrate by using aluminum powder with 1.0 μm grain size thereof; and
(22) polishing the surfaces of the at least one first substrate and the second substrate by using aluminum powder with 0.3 μm grain size thereof.

12. The method for manufacturing the high-temperature solder with multi-layer structure of claim 9, wherein the alkaline solution used in the step (4) is 25% ammonia water.

13. The method for manufacturing the high-temperature solder with multi-layer structure of claim 9, wherein the acid solution used in the step (5) is 10% hydrochloric acid.

14. The method for manufacturing the high-temperature solder with multi-layer structure of claim 9, wherein the first substrate is a cooper substrate.

15. The method for manufacturing the high-temperature solder with multi-layer structure of claim 9, wherein the second substrate is a cooper substrate.

16. The method for manufacturing the high-temperature solder with multi-layer structure of claim 9, wherein the first metal electroplating solution used in the step (7) is selected from the group consisting of: tin electroplating solution, silver electroplating solution and tin-silver composite electroplating solution.

17. The method for manufacturing the high-temperature solder with multi-layer structure of claim 9, wherein the second metal electroplating solution used in the step (8) is selected from the group consisting of: nickel electroplating solution, tungsten electroplating solution, molybdenum electroplating solution, and palladium electroplating solution.

18. The method for manufacturing the high-temperature solder with multi-layer structure of claim 9, wherein the third metal electroplating solution used in the step (9) is indium electroplating solution.

19. The method for manufacturing the high-temperature solder with multi-layer structure of claim 9, wherein the solid-liquid interdiffusion joint in the step (11) is completed through a reflow soldering process.

20. The method for manufacturing the high-temperature solder with multi-layer structure of claim 9, wherein the aging heat treatment in the step (12) is completed by disposing the first substrate and the second substrate in an environment with a specific temperature for 50, 100, 200, 400, 800, 1000, and 1500 hours, respectively.
